(19) United States
(12) Patent Application Publication
(10) Pub. No.: US 2022/0414652 A1
(43) Pub. Date: Dec. 29, 2022

(54) Prioritizing Holds When Selecting Transactions for Transaction-Based Knowledge-Based Authentication

(71) Applicant: Capital One Services, LLC, McLean, VA (US)

(72) Inventors: Joshua Edwards, Philadelphia, PA (US); David Septimus, New York, NY (US); Jenny Melendez, Falls Church, VA (US); Samuel Rapowitz, Roswell, GA (US); Viraj Chaudhary, Katy, TX (US); Daniel Miller, Astoria, NY (US); Tyler Maiman, Melville, NY (US)

(21) Appl. No.: 17/355,709

(22) Filed: Jun. 23, 2021

(51) Int. Cl. G06Q 20/38; G06Q 40/02

(52) U.S. Cl. CPC G06Q 20/388; G06Q 40/02; G06Q 20/407

(57) ABSTRACT

Aspects discussed herein may relate to techniques for authenticating a user using transaction-based authentication questions. Hold transactions conducted using a financial account may be identified and verified. The hold transactions may be transactions that do not post to the financial account, and therefore are not provided on any financial account statement. The transaction-based authentication questions may be generated based on the identified and verified hold transactions. The user may be authenticated based on responses by the user to the transaction-based authentication questions. Malicious actors that gain access to financial account statements are unlikely to answer the transaction-based authentication questions correctly as they are based on financial transaction data that is not provided on the financial account statements.

### FIELD OF USE

Aspects of the disclosure relate generally to authenticating a user. More specifically, aspects of the disclosure provide techniques for generating transaction-based authentication questions based on non-posted transactions.

### BACKGROUND

Financial accounts may be maintained by a financial institution. A user may be required to be authenticated in order to grant a request from the user to access sensitive information or to perform a financial transaction associated with the financial account. Conventional systems for authenticating the user may generate transaction-based questions using any data from transactions conducted using the financial account. These conventional systems may grant the request from the user if the user provides a correct answer to a transaction-based question posed to the user. These conventional systems, however, fail to account for the possibility that a malicious actor may gain access to an issued financial account statement (e.g., a paper financial account statement) that provides details on transactions conducted using the financial account. In doing so, the malicious actor may be able to review the issued financial account statement to answer the transaction-based questions used for authentication. The authentication process may then be circumvented and the malicious actor may be mistakenly granted access to the financial account, thereby frustrating the purpose of the authentication process and rendering the financial account vulnerable to fraudulent activity.

Aspects described herein may address these and other problems, and generally enable a user to be verified in a more reliable and robust manner, thereby improving the integrity of the authentication process.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may provide techniques for authenticating a user using transaction-based questions that are based on non-posted transactions of a financial account. The non-posted transactions may be associated with authorization holds, which may include, for example, refundable deposits that are often required by a car rental company when renting a car or by a hotel when reserving and staying at a hotel. Authorization hold transactions may involve temporary transactions—for example, transactions that indicate an authorization status of pending or cancelled for a period of time but that are not ultimately included in any issued financial account statement (e.g., a paper financial account statement, either mailed or available online). Financial transaction data of a financial account may be reviewed or processed to identify candidate authorization hold transactions. The candidate authorization hold transactions may be verified based on a comparison to a known listing of merchants (e.g., based on comparison to certain merchant category codes (MCCs)) that are known to initiate or be associated with authorization hold transactions. The verified candidate authorization hold transactions may form a set of modified transactional data that is used to generate an authorization question. A user may be authenticated based on the user providing a correct answer to the authorization question. By generating authentication questions based on transactions that do not appear on any issued financial account statement, the authentication process is less likely to be circumvented by a malicious actor that gains access to an issued financial account statement. In turn, the authentication process is more reliable and less susceptible to fraudulent activity that could be caused by erroneously granting the malicious actor access to the financial account.

For example, some aspects described herein may provide a computer-implemented method for authenticating a user using transaction-based authentication question that are based on non-posted transactions. Corresponding apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 illustrates an operating environment in which transaction-based authentication questions may be generated for authenticating a user;

FIG. 3 illustrates an example of an authentication question that may be presented to a user; and

FIG. 4 illustrates an example method for authenticating a user using transaction-based authentication question that are based on non-posted transactions.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to methods and techniques for authenticating a user. A user may be authenticated using transaction-based authentication questions (e.g., knowledge-based authentication (KBA)). The transaction-based authentication questions may be based on transactions involving an authorization hold. For example, the transactions may be or may have an authorization status of “pending” or “cancelled.” Such transactions may be non-posted transactions that are not shown in an issued account statement (e.g., paper account statement). Such transactions may be considered temporary or hold transactions (e.g., authorization hold transactions). Certain merchants such as hotels and car rental companies often require a customer to authorize a deposit to conduct a transaction (e.g., to use a rental car or to stay in a hotel room). Such a deposit may have a pending authorization status for some period of time. However, after the car rental period or hotel stay, the authorized deposit may be refunded (e.g., the pending transaction may be canceled). In turn, data related to the deposit transaction may not be included into any issued financial account statement (e.g., a mailed-out paper statement or an online account summary), and therefore may be considered to be a non-posted transaction. Financial data of an account may be processed to identify candidate authorization hold transactions (e.g., transactions that will not post). A merchant category code (MCC) associated with an identified candidate authorization hold transaction may be compared to a known list of merchant categories that typically initiate authorization hold transactions to verify the candidate authorization hold transaction as such. Transaction-based authentication questions may then be generated based on the verified candidate authorization hold transaction. In doing so, the authentication questions and process offer enhanced security, since they are based on transaction data that is unlikely to show up as a posted transaction on an issued account statement that a malicious actor may obtain and use to attempt to circumvent the authentication process.

Aspects described herein improve the functioning of computers by improving the way in which computing devices authenticate a user. Conventional computing devices implementing conventional techniques for authenticating a user may not consider the risk of basing authentication on transactions that post to an account and therefore are readily available on a provided financial account summary document. A malicious actor that obtains access to a financial account statement may be able to use the statement to answer transaction-based authentication questions used to grant or deny access to the financial account. As a result, the integrity of the authentication process may be compromised. As a further result, the malicious actor may be authorized by mistake, making the financial account vulnerable to fraudulent activity. Significant time and energy must then be expended to deal with the fallout of fraudulent activity related to the financial account. By providing improved authorization techniques—for example, by identifying financial transactions that are likely not to be provided on a financial account statement and basing transaction-based authentication questions on these transactions—authorization may be conducted more accurately and efficiently with lower risk that a malicious actor is mistakenly granted authorization. Over time, the processes described herein may save processing time, network bandwidth, and other computing resources. Moreover, such improvement cannot be performed by a human being with the level of accuracy obtainable by computer-implemented techniques to ensure accurate authentication of a user and improved detection of a malicious actor.

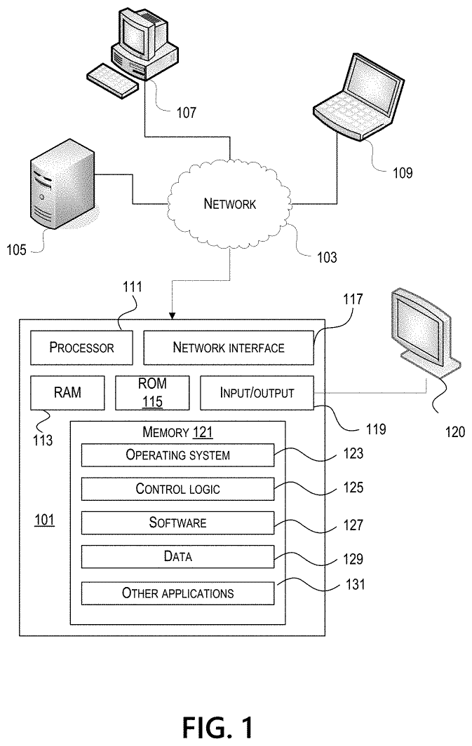

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may implement one or more aspects of the disclosure by reading and/or executing instructions and performing one or more actions based on the instructions. The computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may operate in a standalone environment. In others, computing device 101 may operate in a networked environment. As shown in FIG. 1, various network nodes 101, 105, 107, and 109 may be interconnected via a network 103, such as the Internet. Other networks may also or alternatively be used, including private intranets, corporate networks, local area networks (LANs), wireless networks, personal networks (PAN), and the like. Network 103 is for illustration purposes and may be replaced with fewer or additional computer networks. A LAN may have one or more of any known LAN topologies and may use one or more of a variety of different protocols, such as Ethernet. Devices 101, 105, 107, 109 and other devices (not shown) may be connected to one or more of the networks via twisted pair wires, coaxial cable, fiber optics, radio waves, or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, software 127, data 129, and other applications 131. Control logic 125 may be incorporated in and may be a part of software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, devices 101, 105, 107, 109, and others may operate in concert to provide parallel computing features in support of the operation of control logic 125 and/or software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

Having discussed several examples of computing devices which may be used to implement some aspects as discussed further below, discussion will now turn to various examples for generating transaction-based authentication questions using hold transactions (e.g., authorization hold transactions, transactions that will not post to any issued account summary, and/or transactions that have an authorization status of pending or cancelled).

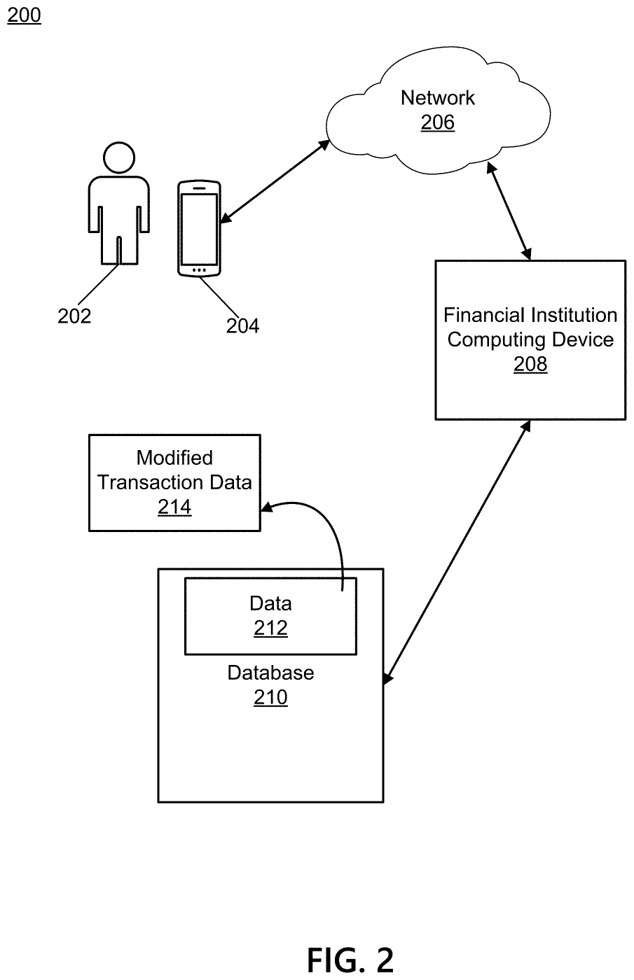

FIG. 2 illustrates an operating environment 200 in which transaction-based authentication questions may be generated for authenticating a user. As shown in FIG. 2, the operating environment may include a user 202, a user computing device 204, a network 206, a financial institution computing device 208, and a database 210.

The user 202 may be any individual or may represent a legal entity. The user computing device 204 may be any type of computing device, including any computing device depicted and described in relation to FIG. 1. The user computing device 204 may be, for example, a smartphone, a laptop, or a tablet. The user computing device 204 may be a wireless device such as, for example, a portable wireless computing device.

The user computing device 204 may be associated with the user 202. The user 202 may use the user computing device 204 to access secure or sensitive information associated with a financial account. The user 202 may use the user computing device 204 to request performance of a transaction associated with a financial account. The user 202 may be or might not be authorized to access sensitive information associated with a financial account. The user 202 may be or might not be authorized to issue a request to conduct a transaction associated with the financial account. As an example, the user 202 may be the true-named-person of the financial account (e.g., the user 202 may or might not be an owner, an authorized user, or an account holder of the financial account subject to a request). As another example, the user 202 may be a malicious actor intending to gain unauthorized access to a financial account.

The network 206 may communicatively couple the user computing device 204 with the financial institution computing device 208. The network 206 may be any type of communications and/or computer network. The network 206 may include any type of communication mediums and/or may be based on any type of communication standards or protocols. The network 206 may be the same or similar to the network 103 of FIG. 1. The network 206 enables data or other information to be shared between the user computing device 204, the financial institution computing device 208, and the database 210.

The financial institution computing device 208 may be any type of computing device including any computing device depicted and described in relation to FIG. 1. The financial institution computing device 208 may be associated with a financial institution. For example, the financial institution computing device 208 might be a server associated with a particular financial institution. The financial institution computing device 208 may represent one or more computing devices and/or a computer network associated with the financial institution. The financial institution computing device 208 may include one or more computers, servers, and/or databases. The financial institution may be a bank, credit union, credit card company, or any other type of financial institution that may provide one or more financial accounts to an individual or legal entity.

The user 202 associated with the user computing device 204 may have one or more financial accounts with the financial institution associated with the financial institution computing device 208. The user 202 may have a checking account, a savings account, a line of credit, and/or a credit card account provided through the financial institution associated with the financial institution computing device 208. In general, the user 202 associated with the user computing device 204 may have any type of financial account with the financial institution associated with the financial institution computing device 208.

Alternatively, the user 202 may be a malicious actor that seeks access or use of a financial account maintained by the financial institution computing device 208. That is, the user 202 may not be an authorized user of a financial account maintained by the financial institution computing device 208 and may seek to access or use the financial account without authorization or in any other nefarious manner.

As an example, the user 202 may have a financial account with the financial institution associated with the financial institution computing device 208. The financial account may be associated with a payment card of the user 202. The payment card may be any type of card such as, for example, a credit card, a payment card, a debit card, a corporate card, or a prepaid card. The user 202 may conduct transactions (e.g., a first set of transactions) with the financial account using the payment card.

The financial institution computing device 208 may store information related to various financial accounts associated with the user 202 (e.g., data or other information related to various transactions for each financial account associated with the user 202). For example, the database 210 may store transactional data associated with one or more accounts the user 202 may have with the financial institution associated with the financial institution computing device 208. The transactional data may include any type of transactional data related to a transaction such as, for example, a date, a time, an amount charged, an amount credited (e.g., an amount refunded), and a merchant name for a transaction. The transactional data may also include stock-keeping unit (SKU) data that may include or may be used to determine an item or service related to a particular transaction (e.g., an item or product purchased during a particular transaction). The transactional data may also store a merchant category code (MCC) for each transaction.

As an example, the database 210 may store transactional data 212 associated with a financial account of the user 202. Accordingly, as the user 202 conducts transactions related to the financial account of the user 202, the database 210 may collect and store the transactional data 212 associated with the transactions.

The user 202 may use the user computing device 204 to attempt to conduct a financial transaction using (e.g., funded by) the financial account maintained by the financial institution computing device 208 and/or the user 202 may use the user computing device 204 to attempt to access sensitive or secure information related to the financial account maintained by the financial institution computing device 208. Any such attempt by the user 202 may trigger the financial institution computing device 208 to verify or authenticate the user 202 (e.g., to ensure the user 202 is allowed to access the requested information or to have a requested transaction conducted). For example, any such attempt by the user 202 may cause the financial institution computing device 208 to operate to authenticate the identity of the user 202 to ensure the user 202 is indeed the individual associated with the financial account and therefore authorized to perform the requested transaction or to access the requested information.

The financial institution computing device 208 may authenticate the user 202 by generating transaction-based questions (e.g., authentication or authorization questions). The authentication questions may be based on transactional data associated with the financial account with which the user 202 requests an action to be performed (e.g., a request to perform a transaction and/or a request to access secure information). The authentication question may be considered to be knowledge-based questions as they require the user 202 to be familiar with underlying data (e.g., transactional data related to a financial account) to answer the questions correctly. Accordingly, the authentication process may be considered to be a knowledge-based authentication (KBA) process.

As an example, the user 202 may request an action be performed relating to the financial account associated with the user 202. In response, the financial institution computing device 208 may receive a request for authorization to perform the action relating to the financial account associated with the user 202. The financial institution computing device 208 may generate one or more authentication questions based on the transaction data 212 associated with the financial account associated with the user 202.

The one or more authentication questions may be directed to any aspect of any transaction conducted using the financial account associated with the user 202. The financial institution computing device 208 may generate the one or more authentication questions based on the transactional data 212 stored in the database 210. As an example, an authentication question may relate to a merchant with which the user 202 has conducted a transaction using the financial account associated with the user 202. The authentication question may ask the user 202 to indicate whether or not the user 202 conducted a transaction with a particular merchant within a particular period of time (e.g., a predetermined period of time prior to the user 202 requesting an action be performed relating to the financial account associated with the user 202). The authentication question may also include or indicate an amount of a transaction or an item or service that may have been purchased. The authentication question may be posed as any type of question including, for example, a true/false (T/F) question, a multiple-choice question, or a yes/no (Y/N) question. The authentication question may be posed in a manner that requests the user 202 to provide an answer either verbally and/or by entering an answer electronically using the user computing device 204 (e.g., via a keypad or touchscreen). The financial institution computing device 208 may also generate a correct or expected answer to the authentication question.

The authentication question may provide one or more correct answers to the user 202 and/or one or more incorrect or false answers to the user 202. The financial institution computing device 208 may authorize the user 202 (e.g., and/or authorize the request to perform the action relating to the first financial account associated with the user 202) based on the response of the user 202.

As an example, the user 202 may be logged into the financial account through a web-based interface. The user 202 may then request a relatively large sum or amount of funds to be transferred to another financial account maintained by another financial institution. The large transfer request may trigger the financial institution computing device 208 to initiate an authentication process of the user 202. The user 202 may have undergone an initial authentication process to gain online access to the account; however, the large transfer request may trigger a more robust and KBA authentication process. The financial institution computing device 208 may then operate in conjunction with the database 210 and the database to further authenticate the user 202.

Many conventional authentication processes and systems may generate and rely on transaction-based questions that involve any type of transaction, including transactions that are posted transactions. That is, many conventional authentication processes and systems may generate and rely on transaction-based questions that involve transactions that are shown (e.g., details of the transaction) on an issued account statement (e.g., a paper statement or an online account summary statement). This renders the conventional authentication processes and systems susceptible to circumvention by a malicious actor that gains access to the issued account statement of the financial account. In particular, a malicious actor that obtains a financial account statement for a financial account may be able to answer transaction-based authentication questions by simply reviewing the data provided on the financial account statement.

To provide a more robust authentication process, techniques described herein may generate and rely on transaction-based questions that involve transactions that do no post to an account—that is, transactions for which data associated with the transaction is not included within a financial account statement. An example of such a transaction may be an authorization hold transaction. Authorization hold transactions may not post to the financial account (as they are temporary and/or are eventually canceled) and so may not be listed as a transaction on the issued account statement of the financial account. A malicious actor that gains access to the issued account statement of the financial account will not gain access to transaction information of the authorization hold transaction, as such information is not provided on the issued account statement. As such, the malicious actor is unlikely to be able to correctly answer a transaction-based authorization question based on an authorization hold transaction. On the other hand, the actual owner of the financial account (or authorized user of the financial account) may be able to easily answer the transaction-based authorization question based on the authorization hold transaction, and be authenticated to perform a request related to the financial account. In this manner, the techniques described herein provide enhanced security when authenticating the user 202.

The techniques described herein, for example, enable the financial instruction computing device 208, to access financial transaction data associated with a financial account (e.g., stored by the database 210). The financial transaction data can include data for any type of transaction over any period of time. Financial transaction data may then be selected that has an authorization status of “pending” or “cancelled,” as transactions with such status may indicate that the transaction is an authorization hold transaction. Accordingly, a first subset of financial transaction data may be provided, based on the overall financial transaction data available to the financial instruction computing device 208 (e.g., which includes only transactions that are likely to be authorization hold transactions).

The first subset of transaction data may then be verified as indeed including data associated with authorization hold transactions. For example, MCCs of the transactions included within the first subset of transaction data may be compared to a known or predetermined list of MCCs. The predetermined list of MCCs may include MCCs representing merchants that typically or often initiate authorization hold transactions. For example, MCCs representing rental car companies and hotels may be included in the predetermined list of MCCs. As an example, the predetermined list of MCCs may include MCCs 3300-3499 (relating to car rentals) or MCCs 3500-3999 (relating to lodging).

Transaction data within the first subset of transaction data that is associated with an MCC that is not found within the predetermined list of MCCs may be removed such that only transactions (and related transaction data) having an MCC found on the predetermined list of MCCs may remain. In this manner, transactions that may not be authorization hold transactions may be filtered out. In turn, a second subset of financial data—which may be represented by modified transaction data 214—may be provided. The modified transaction data 214 may include financial transaction data that is likely to be associated with an authorization hold transaction that, as described herein, is unlikely to post to the financial account and therefore unlikely to be provided on an issued account statement for a financial account. The modified transaction data 214 may be stored in the database 210.

One or more authorization questions may then be generated based on the modified transaction data 214. The authorization questions generated based on the modified transaction data 214 may involve any information associated with the transactions represented by the modified transaction data 214. For example, the user 202 may have recently stayed in a hotel. The hotel may have required the user 202 to provide a deposit (e.g., a deposit of S200) as a condition for staying in the hotel. As part of the authorization process, the financial institution computing device 208 may generate the following authentication question: “How much deposit was required at your recent hotel stay?” The financial institution computing device 208 may then authenticate or not authenticate the user 202 based on the response of the user 202 to this authentication question.

The techniques described herein provide a reliable manner to authenticate a user while providing enhanced security. First, authentication questions based on non-posted transactions (e.g., pending, cancelled, or authorization hold transactions) may be transactions that a user is likely to remember (e.g., at least as likely as a posted transaction) and so involve data that may be harvested for generating an authentication question. Second, by basing the authentication question on data that is not provided on an issued financial account statement (e.g., a month financial account statement), the authentication question cannot be answered by a malicious actor by simply reviewing the financial account statement.

Further, the techniques described herein further ensure that non-posted transactions are correctly identified and used for generation of authentication questions. First, the authorization status of such transactions may be reviewed to determine if the status matching a status of a transaction that may be a transaction that is likely not to post to the account (e.g., transactions with an automerization status of pending or cancelled). Second, any candidate transaction is then verified by a second check—by checking if the merchant related to the candidate transaction is within an MCC that has been preidentified as an MCC that includes merchants that often initiate non-posted transactions.

For example, a pending authorization for S200 may be identified and may be selected as a candidate transaction. Next, the MCC of the candidate transaction may be determined. The determined MCC may then be compared to determined it is on a list of preidentified MCCs. If so, then the candidate transaction has been verified as likely to be a non-posted transaction and so may be used for generation of an authentication question. If not, then the candidate transaction may be discarded and not used for generation of an authentication question. This MCC category check ensures that temporary or other transactions (e.g., refunds, cancellations) that may be confused with non-posted transactions are not used to generate the authentication question, which helps to prevent confusing the user 202. That is, by verifying the candidate transition with the MCC category check, the authentication process is less likely to generate an erroneous authentication question and/or confused the user 202 and induce an incorrect answer from an otherwise authorized user.

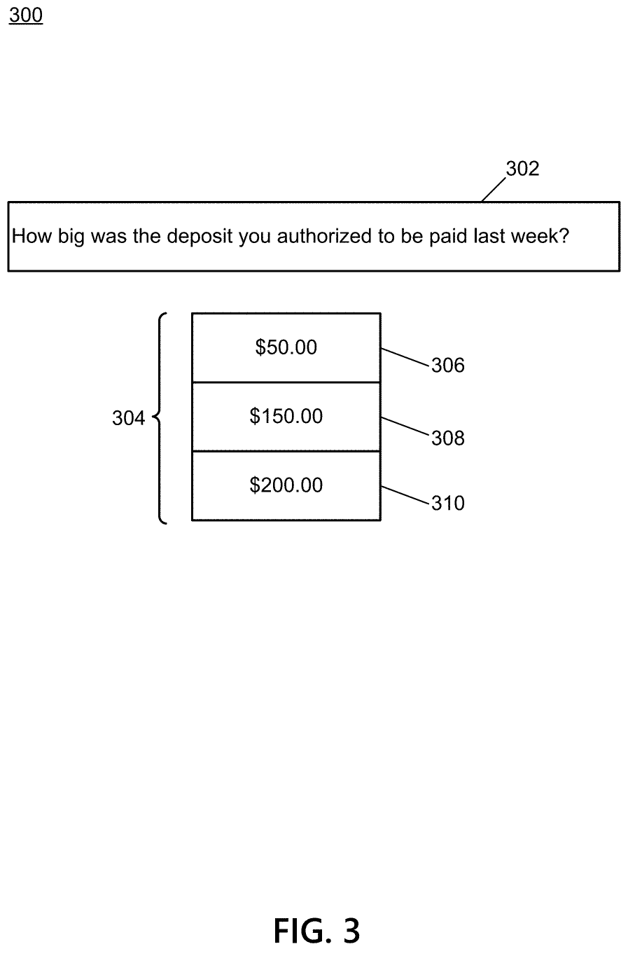

FIG. 3 illustrates an example of an authentication question 300 that may be presented to a user (e.g., the user 202). The authentication question 300 may be presented in any manner to the user. The first authentication question 300 may be presented to the user via a display screen (e.g., a display screen of the user computing device 204). The authentication question 300 may be presented to the user audibly (e.g., via a landline phone or via a speaker of the user computing device 204).

The authentication question 300 may include a prompt 302. The authentication question 300 may further include a set of possible answers 304, that includes a first answer choice 306, a second answer choice 308, and a third answer choice 310. As an example, the owner of a financial account may have checked into a hotel recently (e.g., last week). The hotel may have required a $200.00 deposit as a condition for staying in the hotel. Accordingly, based on the prompt 302, the correct answer to the authentication question 300 may be the third answer choice 310.

If a malicious actor is attempting to use the financial account, the malicious actor may have gained access to a financial account statement of the financial account (e.g., a paper copy of the financial account statement). The financial account statement may include data relating to various transactions involving the financial account but may include no data or indication whatsoever regarding the hotel stay. Accordingly, the financial account statement is of no use in answering the authorization question 300. The authentication process may still reliably block the malicious actor for access to the financial account despite the malicious actor being able to access the financial account statement, while simultaneously still providing a manner for unauthorized user to be reliably authenticated in a straightforward and hassle-free manner.

Discussion will now turn to an example method for generating transaction-based authentication questions in accordance with the techniques described herein.

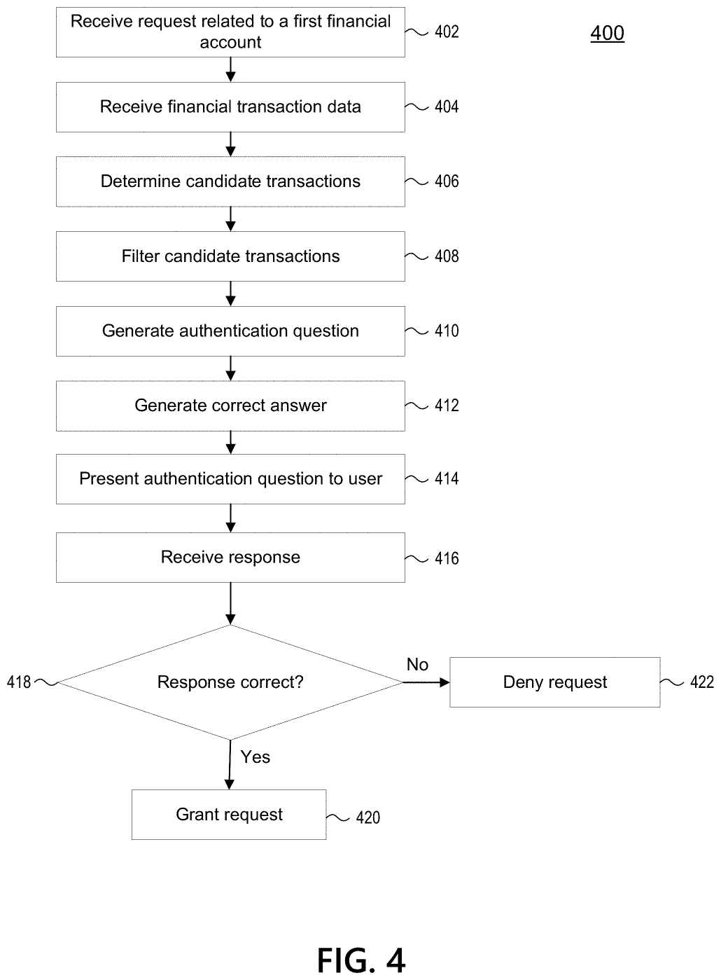

FIG. 4 illustrates an example method 400 for authenticating a user with transaction-based authentication questions based on hold transactions. Candidate transactions that likely involve a hold transaction may be identified. Merchants associated with the candidate transactions may be compared to a set of MCCs that are known to exhibit hold transaction behavior, to verify which candidate transactions are to be categorized as hold transactions. Authentication questions for authenticating a user may then be generated based on the transactions data associated with each of the hold transactions. The user may be authenticated or not based on responses to the authentication questions.

Method 400 may be implemented by a suitable computing system and/or any combination of computing systems or devices, as described herein. For example, method 400 may be implemented in any suitable computing environment by a computing device and/or combination of computing devices, such as computing devices 101, 105, 107, and 109 of FIG. 1 and/or by any one or more of the components depicted in any of FIG. 2 such as, for example, the financial institution computing device 208, the database 210, or any combination thereof. Method 400 may be implemented in suitable program instructions, such as in software 127, and may operate on data, such as data 129.

At step 402, a request for authorization to perform an action relating to a financial account may be received. The request may be initiated by a user. The user may be any individual including, for example, an owner, authorized user, or account holder associated with the financial account. Alternatively, the user may not be an authorized user of the financial account and may be a malicious actor. The action may comprise conducting a financial transaction using the financial account. The action may comprise accessing secure information relating to the financial account. The action may comprise accessing funds of the financial account. The financial account may be any type of account such as, for example, a personal financial account.

At step 404, financial data relating to the financial account of the user may be received. The financial data may be received from one or more databases. The financial data may include any information related to any transaction conducted using the financial account. The financial data may over any predetermined period of time.

Steps 406 and 408 operate to determine one or more hold transactions. The hold transactions may be any type of hold transactions such as, for example, an authorization hold transaction such as those typically initiated by a car rental company or a hotel. At step 406, candidate hold transactions may be determined based on the financial data associated with the financial account. As an example, the financial data may be reviewed and/or processed to determine those transactions that are associated with an authorization status of pending or cancelled, as each status is indicative of a hold transaction. In doing so, a first subset of transactions and related transaction data may be identified. The first subset of transactions may be candidate hold transactions—that is, transactions that are likely to be hold transactions.

At step 408, merchants and/or MCCs of each of the candidate hold transactions may be determined. The merchants and/or MCCs of each of the candidate hold transactions may be compared to a predetermined list of merchants and/or MCCs. The predetermined list of merchants and/or MCCs may include merchants and/or MCCs that typically exhibit hold transaction behavior. That is, the predetermined list of merchants and/or MCCs may include merchants and/or MCCs that are known to initiate authorization hold transactions. The candidate hold transactions may be culled based on the predetermined list of merchants and/or MCCs to remove any transaction that includes a merchant or is associated with an MCC that is not on the predetermined list of merchants and/or MCCs.

Accordingly, steps 406 and 408 operate to generate a modified set of financial transaction data from the initial financial transaction data provided for the financial account. The modified set of financial transaction data includes transactions (and related transactional data) that are likely to be hold transactions. The modified set of financial transaction data may be used to generate authentication question that focus on hold transactions. As described herein, the hold transactions may include a deposit transaction, a canceled transaction, and/or a pending transaction. As an example, candidate transactions may be identified and data for such transactions may be filtered out. This data can then be verified to form modified data. Alternatively, candidate transaction may be identified and then verified before any filtering of data occurs—such that after verifying which transactions are indeed hold transactions, the modified set of data is determined.

The steps 406 and 408 may operate to (1) determine a set of candidate transactions (e.g., hold transactions) form a larger set of transactions; (2) determine the merchants and/or MCCs of each of the candidate transactions; (3) compare the merchants and/or MCCs of each of the candidate transactions to a one or more predetermined lists of merchants or MCCs of merchants that are known to initiate hold transactions; (4) determine a modified set of candidate transactions (e.g., that may be the same size or smaller than the initial set of candidate transactions), with each transaction in the modified set of transactions associated with a merchant or an MCC provided on the one or more predetermined lists of merchants or MCCs of merchants that are known to initiate hold transactions. In doing so, the available set of financial transaction data for the financial account may be culled to provide a subset of transactions matching criteria described herein for being (or likely being) a hold transaction.

At step 410, an authorization question for determining whether to perform the action relating to the financial account may be generated. The authorization question may be generated based on the modified set of financial data. The authorization question may be a transaction-based question relating to the financial account. The authorization question may be generated based on the determined merchant or MCC of a hold transaction determined from steps 406 and 408.

As an example, the authorization question may include a request to indicate whether a transaction was conducted with one or more merchants associated with one or more authorization hold transactions that may be identified. As another example, generating the authentication question may include determining an amount of a transaction conducted with one or more merchants associated with one or more authorization hold transactions that may be identified. As a further example, generating the authentication question may include generating a request to indicate an amount of a transaction conducted with one or more merchants associated with one or more authorization hold transactions that may be identified.

At step 412, a correct answer to the authorization question may be generated. The correct answer may be generated based on the modified set of financial data and the authorization question. The correct answer to the authorization question may be generated based on the determined merchant or MCC of a hold transaction determined from steps 406 and 408.

At step 414, the authorization question may be presented to the user. The authorization may be presented to the user in any manner. For example, the authorization question may be provided verbally by a customer service representative (e.g., over a telephone connection). The authorization may also be caused to be displayed to the user (e.g., on a display of a computing device of the user). The authorization question may be any type of transaction-based question regarding the modified set of financial data including, for example, a question whether the user conducted a particular transaction at a particular merchant within a particular time period. The authentication question may include a request to indicate whether the account holder conducted a transaction with a particular merchant, if the account holder authorized a particular hold transaction with a particular merchant, or the amount of a particular hold transaction. The authorization question may also include a set of answer choices with one or more correct answers and/or one or more incorrect answers. The authorization question may prompt the user to answer the authorization question.

At 416, a response to the authorization question may be received. The response may be received as a verbal response and/or as a response provided though a computing device (e.g., by provided a touch-based input, keyed data entry, or other electronic data entry mechanism).

At 418, the response may be compared to the correct answer. If the response matches the correct answer, then at step 420, the request for authorization may be granted. If the response does not match the correct answer, then at step 422, the request for authorization might not be granted. In this manner, a determination whether to grant the request for authorization to perform the action relating to the financial account may be based on the response to the authorization question.

Any of the techniques described herein for generating authentication questions may be implemented within a call center environment. For example, the user 202 may use a landline telephone or cellphone to call a call center (or may receive a call from a call center) to effectuate authentication. A call center representative may read an authentication question (including any answer choices) to the user 202 (or an authentication question may be displayed on a device used by the user). The user 202 may answer the authentication questions verbally so that the call center representative may hear the verbal response. The user 202 may then be authenticated or not authenticated based on the verbal response of the user 202.

The steps described above in relation to FIG. 4 may be performed in any manner. For example, the method 400 may be performed so that the modified set of financial data is determined prior to receiving a request for authentication or a correct answer to an authorization question may be determined before the exact authentication question is generated.

The techniques described herein for identifying hold transactions of a financial account and basing the authentication process on transaction-based questions that rely on data associated with the hold transactions further ensure that the authentication process is not circumvented by a malicious actor that gains access to a financial account summary. Further, the techniques described herein ensure that the transaction-based authentication questions are based on data associated with hold transactions and not based on other transactions that mistakenly could be assumed to be a hold transaction. The techniques described herein compare merchant information (e.g., a merchant name, identifier, and/or an MCC) for candidate transactions to a known set of merchants and/or MCCs that typically initiate hold transactions. In doing so, authentication questions based on the hold transactions are less likely to confuse an actual authorized user of the financial account (e.g., by not mistakenly asking a transactions-based questions related to a transaction that is actually not a hold transaction). Accordingly, authorized users may be verified more efficiently and with added protection against malicious actors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving a request for authorization to perform an action relating to a financial account;
receiving, from one or more databases, financial transaction data relating to the financial account for a predetermined period of time;
determining, based on the financial transaction data, one or more authorization hold transactions;
generating, based on the one or more authorization hold transactions, modified financial transaction data, the modified financial transaction data excluding financial transaction data not associated with the one or more authorization hold transactions;
generating, based on the modified financial transaction data, an authorization question for determining whether to perform the action relating to the financial account;
generating, based on the modified financial transaction data and the authorization question, a correct answer to the authorization question;
causing display of the authorization question;
receiving a response to the authorization question; and
determining whether to grant the request for authorization to perform the action relating to the financial account based on the response to the authorization question.

2. The method of claim 1, wherein generating the modified financial transaction data comprises determining one or more merchant category codes (MCCs) associated with the one or more authorization hold transactions, wherein generating the authorization question and generating the correct answer to the authorization question are based on the one or more MCCs.

3. The method of claim 1, wherein generating the authorization question comprises determining one or more merchants associated with the one or more authorization hold transactions.

4. The method of claim 3, wherein generating the authorization question comprises generating a request to indicate whether a transaction was conducted with the one or more merchants associated with the one or more authorization hold transactions.

5. The method of claim 3, wherein generating the authorization question comprises determining an amount of a transaction conducted with the one or more merchants associated with the one or more authorization hold transactions.

6. The method of claim 5, wherein generating the authorization question comprises generating a request to indicate the amount of the transaction conducted with the one or more merchants associated with the one or more authorization hold transactions.

7. The method of claim 1, wherein the one or more authorization hold transactions comprise a deposit transaction.

8. The method of claim 1, wherein the one or more authorization hold transactions comprise a canceled transaction.

9. The method of claim 1, wherein the one or more authorization hold transactions comprise a pending transaction.

10. The method of claim 1, wherein determining whether to grant the request for authorization further comprises comparing the response to the authorization question to the correct answer to the authorization question.

11. The method of claim 10, further comprising granting the request for authorization based on the response to the authorization question matching the correct answer to the authorization question.

12. The method of claim 10, further comprising denying the request for authorization based on the response to the authorization question not matching the correct answer to the authorization question.

13. The method of claim 1, wherein the action comprises accessing funds of the financial account.

14. The method of claim 1, wherein the action comprises accessing secure information relating to the financial account.

15. A computer-implemented method, comprising:
receiving a request for authorization to perform an action relating to a financial account;
receiving, from one or more databases, financial transaction data relating to the financial account for a predetermined period of time;
determining, based on the financial transaction data, one or more authorization hold transactions;
generating, based on the one or more authorization hold transactions, modified financial transaction data, the modified financial transaction data excluding financial transaction data not associated with the one or more authorization hold transactions;
generating, based on the modified financial transaction data, an authorization question for determining whether to perform the action relating to the financial account;
generating, based on the modified financial transaction data and the authorization question, a correct answer to the authorization question;
causing display of the authorization question;
receiving a response to the authorization question;
comparing the response to the authorization question to the correct answer to the authorization question;
determining the response to the authorization question does not match the correct answer to the authorization question; and
determining to deny the request for authorization to perform the action relating to the first financial account based on determining the response to the authorization question does not match the correct answer to the authorization question.

16. The computer-implemented method of claim 15, wherein generating the authorization question comprises determining one or more merchants associated with the one or more authorization hold transactions.

17. The method of claim 16, wherein generating the authorization question comprises generating a request to indicate whether a transaction was conducted with the one or more merchants associated with the one or more authorization hold transactions.

18. The method of claim 16, wherein generating the authorization question comprises determining an amount of a transaction conducted with the one or more merchants associated with the one or more authorization hold transactions.

19. The method of claim 18, wherein generating the authorization question comprises generating a request to indicate the amount of the transaction conducted with the one or more merchants associated with the one or more authorization hold transactions.

20. One or more non-transitory media storing instructions that, when executed by one or more processors, cause the one or more processors to perform steps comprising:
receive a request for authorization to perform an action relating to a financial account;
receive, from one or more databases, financial transaction data relating to the financial account for a predetermined period of time;
determine, based on the financial transaction data, one or more authorization hold transactions;
generate, based on the one or more authorization hold transactions, modified financial transaction data, the modified financial transaction data excluding financial transaction data not associated with the one or more authorization hold transactions;
generate, based on the modified financial transaction data, an authorization question for determining whether to perform the action relating to the financial account;
generate, based on the modified financial transaction data and the authorization question, a correct answer to the authorization question;
cause display of the authorization question;
receive a response to the authorization question; and
determine whether to grant the request for authorization to perform the action relating to the first financial account based on the response to the authorization question.
